(19) United States
(12) Patent Application Publication
(10) Pub. No.: US 2010/0285689 A1
(43) Pub. Date: Nov. 11, 2010

(54) Power strip with 110 and 220 volt outlets

(76) Inventor: Danny M. Cook, Missouri City, TX (US)

Correspondence Address: Danny M. Cook, 3507 Golden Tee Lane, Missouri City, TX, 77459, US

(21) Appl. No.: 12/592,750

(22) Filed: Dec. 2, 2009

Related U.S. Application Data
(60) Provisional application No. 61/215,913, filed on May 11, 2009.

(51) Int. Cl. H01R 27/02; H01R 3/00

(52) U.S. Cl. 439/488; 439/650

(57) ABSTRACT

A mechanism that will provide 220 volts AC when the devise is properly plug-in to two home duplex outlets as shown in the attached drawing Figure Two and described in Summery of the Invention. The devise will also provide current in excess of 30 amperes at 110 volts when properly plug-in to two home duplex outlets as shown in the attached drawing Figure Three and described in Summery of the invention.

### CROSS-REFERENCE TO RELATED APPLICATIONS

This application claims the benefit of provisional patent application Ser. No. 61/215,913 filed 2009 May 11 by the present inventor.

### FIELD OF INVENTION

The present invention relates to electrical connections, such as power strips, having at least one 110 volt receptacle, or outlet, and at least one 220 volt receptacle, or outlet, for receiving electrical plugs of various tool or appliances.

### BACKGROUND OF INVENTION

Convention power strips and surge protectors, which enable a number of electrical devices to be connected to a single power source, are well known. Power strip are frequently used where there are a number of electrical devices in close proximity that all demand power simultaneously. For example, power strips that include surge protectors are commonly used in households for electrical devices such as entertainment centers and computers. Power strips without surge protection are frequently used for lamps, tools and small appliances. Common power strips include an elongated housing with a number of outlets aligned in rows along one or more surfaces of the strip. Each outlet is configured to receive an electrical plug of a tool or appliance. When coupled to the power strip, the plug typically extends upward from and transverse to, the surface of the housing. The strip also includes a power cord with one end fitted with a male electrical plug to obtain power from a traditional electricity source and the other end connected to the housing. Conventional power strips also sometimes include a switch which can be used to turn off power to all outlets on the strip when connected to source.

Quite often the nearest electrical power supply can be a distance from the electrical tools being used. This situation requires that extension cords be run to facilitate the use of electric tools. Conventional power strips are used on projects so that separate extension cords do not have to be used for each electrical device. Power strips are placed in close proximity to the work location so that quick and convenient access too many electrical outlets are available. This enables numerous workers to plug in their electrical devices simultaneously without disrupting the power supply for other workers. Also several tools can be plugged in simultaneously ready for use as required.

Many devises used in household repair and remodeling require more than 15 amps at 110 volts. Most home outlets are 15 amps at 110 volts. When an electrical device exceeds 15 amps at 110 volts and trips the circuit breaker, work is halted and the household is disrupted. Disruption of power and restoration often requires reprogramming or reconfiguring of many modem devices and can cause damage. Also some devises used in household repair and remodeling require a 220 volt circuit. There are, most likely, no unused 220 volt circuits in homes that can be used for repair or remodeling. Often electrician's services are required to provide a temporary 220 volt circuit adding to cost and complexity.

### SUMMERY OF THE INVENTION

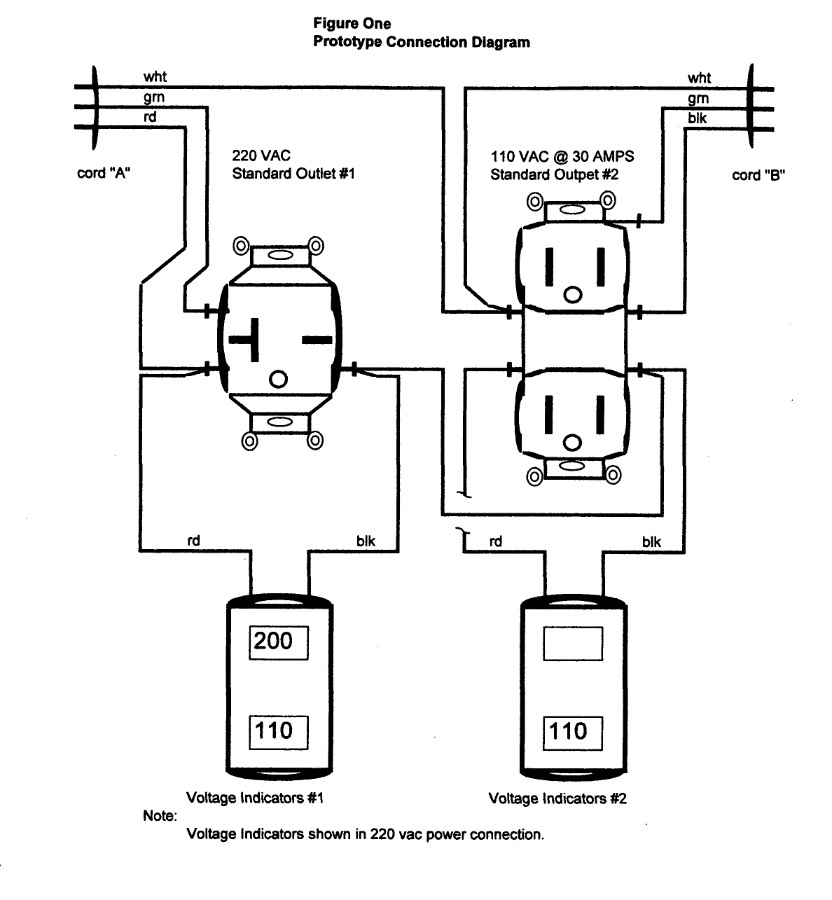

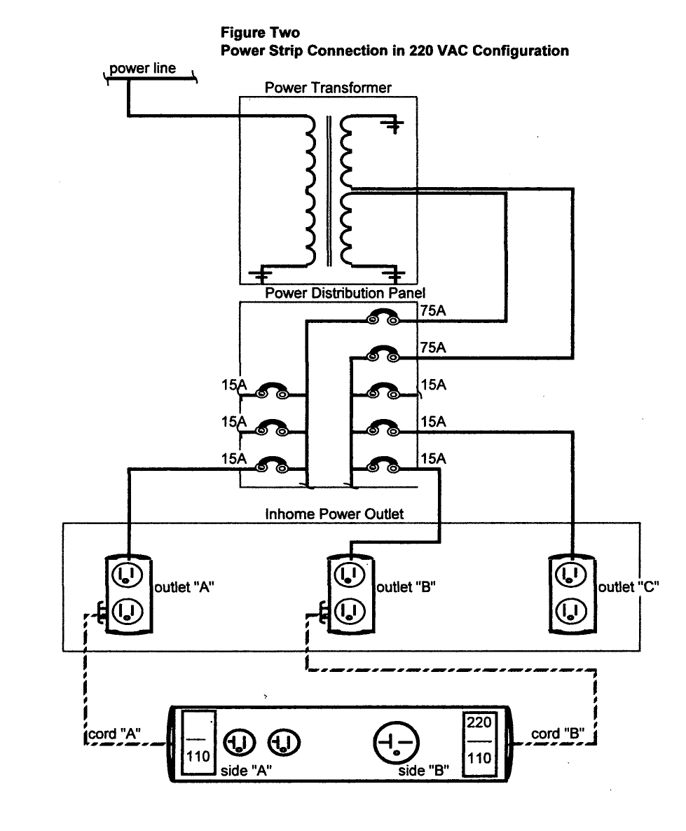

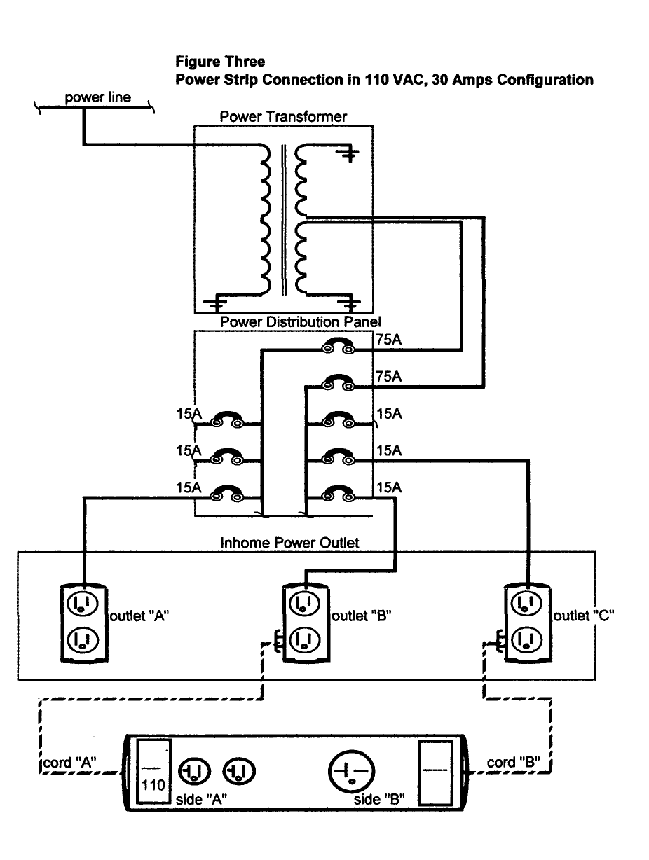

For the sake of testing a prototype assembly was built using standard off the shelf components as shown in Picture #1 near by. FIG. 1 shows these standard components and their wiring. When the invention is connected in the configuration as shown in FIG. 3, 110 volts AC at 30 amperes is provided to a single devise that requires more than 15 amperes at 110 volts AC without tripping the circuit breaker. This is the advantage of the invention for this configuration. No other device or like configuration can provide this value in the normal household for household repair, remodeling, and cleaning projects. When the invention is connected in the configuration shown in FIG. 2, 220 volts AC at is provided. This is the advantage of the invention when connected in this configuration. A 220 volt circuit at 15 amperes is provided without any additional wiring. No other device or like configuration can provide this value in the normal households for household repair, remodeling, and cleaning projects.

### DRAWINGS—Figures

Figure One titled “Prototype Connection Diagram” shows an off the shelf 220 VAC Standard Outlet #1 with an off the shelf Voltage Indicator #1. Also shown is a off the shelf 110 VAC Standard Outlet #2 with an off the shelf Voltage Indicator #2. Cord “A” and associated wiring and Cord “B” and associated wiring are also shown.

Figure Two titles “Power Strip Connected in 220 VAC Configuration” shows a typical Power Transformer and power line provided by the utility company, a Power Distribution Panel and outlets which are a part of the home owners property. When the Power Master devise is connected as follows 220 VAC is provided:

For 220 VAC power in the home two 110 VAC sources 180 degrees out of phase are required. When Cord “A” is connected first, side “A” meter indicates 110 VAC. Cord “B” can be moved from outlet to outlet until another 110 VAC source can be found that is 180 degrees out of phase from the first. Then side “B” meter will indicate 220 VAC as well as 110 VAC. There is also 110 VAC available from the side “A” outlet.

Figure Three titles “Power Strip Connected in 110 VAC 30 Amps Configuration” shows a typical Power Transformer and power line provided by the utility company, a Power Distribution Panel and outlets which are a part of the home owners property. When the Power Master devise is connected as follows 110 VAC at 30 amps is provided:

For 110 VAC power in the home two 110 VAC sources on separate circuit bakers are required. When Cord “A” is connected first, side “A” meter indicates 110 VAC. Cord “B” can be moved to some distant outlet until another 110 VAC source can be found on a different circuit baker. Usually outlets that are on the same circuit baker are located in close proximity to each other. The side “B” meter will indicate 110 or 220 VAC since either one is available

What is claimed:

1. Power Strip
a 1^{st} AC power source
a 2^{nd} AC power source
at least one AC power outlet

2. The power strip of claim 1 where in said AC power outlet is a 220 AC volt outlet.

3. The power strip of claim 1 where in said AC power outlet is greater than 15 amps capacity.

4. The power strip of claim 1 where in said AC power outlet has voltage indication.

5. The power strip of claim 1 where in said AC power has at least two AC outlets.

6. The power strip of claim 1 where in said AC power outlet has one each voltage indicator for each voltage level 110 AC volts and 220 AC volts.

7. A power strip comprising
a 1^{st} AC power source
a 2^{nd} AC power source
an AC power outlet capable of 220 VAC
an AC power outlet capable of 110 VAC at greater than 15 amps.
a voltage indicator connected to the 220 VAC power outlets
a voltage indicator connected to the 110 VAC power outlets
